(19) United States
(12) Patent Application Publication
(10) Pub. No.: US 2025/0100790 A1
(43) Pub. Date: Mar. 27, 2025

(54) DEBRIS COLLECTION HOPPER AND METHODS

(71) Applicant: Federal Signal Corporation, Downers Grove, IL (US)

(72) Inventor: Xiaolun Huang, Naperville, IL (US)

(21) Appl. No.: 18/823,333

(22) Filed: Sep. 3, 2024

Related U.S. Application Data
(60) Provisional application No. 63/540,825, filed on Sep. 27, 2023.

(51) Int. Cl. B65D 88/56; B01D 45/02; B01D 45/04; B01D 46/71; B01D 50/20; E01H 1/08

(52) U.S. Cl. CPC B65D 88/56; B01D 45/02; B01D 45/04; B01D 46/71; B01D 50/20; E01H 1/0827; B01D 2279/40

(57) ABSTRACT

A debris collection hopper for road surface maintenance vehicles, such as street sweepers and road mark line removers separates and retains debris according to their sizes inside a hopper of the pneumatic conveyance system. The air stream flows through three divided compartments—main storage area for coarse or bulky debris, low pressure drop pre-separator for fine particles, and filter housing for extra fine dusts. Each compartment has a common open end closed by a single door. During discharge, opening the door empties all the compartments. The hopper effectively collects debris from the pneumatic conveyance system, reduce clogging in filters and increasing productivity, while still being compact and simple to operate.

### CROSS-REFERENCE TO RELATED APPLICATIONS

This application claims priority to U.S. provisional patent application 63/540,825 filed on Sep. 27, 2023; the disclosure of which is incorporated herein by reference in its entirety.

### TECHNICAL FIELD

The present disclosure related to debris collection system in road surface maintenance vehicles, such a street sweeper and mark line removal trucks, and, more particularly, for a hopper to effectively collect different sizes of debris while maintaining a compact size and ease of operation.

### BACKGROUND

Debris collection hopper is an important component in road surface maintenance vehicles. Most of these vehicles use pneumatic conveyance systems to transfer debris from the working spot to a storage hopper. The challenge is that it inherently requires good separation of debris from the air stream, which inevitably demands bigger hopper space for sediment. In many applications with restricted regulations, complicated air filtration is necessary. On the other hand, like any other road vehicles, collection hopper size is limited. In addition, a separated filter housing is normally not desirable, due to requiring extra discharging operation, more space and higher cost. Therefore, filters are often built into the storage hopper, such that sediment from the filters and the main debris share the same hopper storage area, separated with various baffles. While such an arrangement is able to discharge the main debris and filter sediment together, a drawback is that baffles are generally not sufficient to reduce the dropped dust cloud to re-enter the filters. This problem is very common to hoppers with built-in filters.

There were attempts to use cyclones to pre-separate the dust. But its associated high pressure loss affects performance of the vacuum system, especially when using fans as vacuum generators.

Therefore, it is desirable to have an improved debris collection hopper for road surface maintenance trucks that is compact in size, easy to operate and maintain, and reduces filter clogging.

### SUMMARY

In general, a debris collection hopper is provided that improves the prior art. It is compact in size, easy to operate and maintain, and reduces clogging of the filter. It will allow the filters to continuously work up to the hopper full storage capacity, to extend the service up time.

In one aspect, a debris collection and storage hopper system for use with a pneumatic conveyance system using a blower or fan to pickup debris from road surfaces is provided. The system comprising: a hopper having a surrounding wall and an interior volume; at least one inlet in air-flow communication with the hopper interior volume conveying a debris-entrained air stream; an outlet in air-flow communication with the hopper interior volume conveying a filtered air stream; partition walls dividing the hopper interior volume into three compartments sequentially separating debris by mass and size, wherein the three compartments are constructed substantially across a length of the hopper with one end closed and another end selectively openable; a door covering the openable end of the compartments; and a pivot and actuator to selectively tilt the hopper for emptying through the openable ends.

In an example embodiment, the three compartments include: a first compartment positioned to receive the air stream directly from the inlet and to collect heavy and bulky debris; a second compartment having a throat and tuning profile to provide a low-pressure-drop separator to separate and retained coarse dust; and a third compartment housing one or more filters for fine dust separation and retaining.

In another aspect, a vehicle is provided. The vehicle comprises a pneumatic conveyance system using blower or fan to pickup debris from road surfaces; the debris being conveyed into an inlet of a debris collection and storage hopper system, as provided above.

A debris collection hopper for road surface maintenance vehicles, such as street sweepers and road mark line removers separates and retains debris according to their sizes inside a hopper of the pneumatic conveyance system. The air stream flows through three divided compartments-main storage area for coarse or bulky debris, low pressure drop pre-separator for fine particles, and filter housing for extra fine dusts. Each compartment has a common open end closed by a single door. During discharge, opening the door empties all the compartments. The hopper effectively collects debris from the pneumatic conveyance system, reduce clogging in filters and increasing productivity, while still being compact and simple to operate.\

A compact hopper is provided having three compartments with common open end and using a single door to close and discharge them all together and the same time.

A debris collection hopper is provided to improve the collection productivity of the pneumatic conveyance system in road service trucks. It will allow the filters to continuously work up to the hopper full storage capacity, so that extends the service up time.

In one aspect, the system separates the filter sediment compartment from the main debris area and optimizes the air flow direction to reduce the falling dust to re-enter the filter, so that reduces the chance of premature clogging.

In another aspect, a method of picking up debris from road surfaces is provided. The method comprising: conveying a debris-entrained air stream into an interior of a hopper from an inlet; conveying the air stream into a first compartment in the hopper positioned to receive the air stream directly from the inlet and collecting heavy and bulky debris; then conveying the air stream into a second compartment, downstream of the first compartment, having a throat and tuning profile to provide a low-pressure-drop separator to separate and retain coarse dust; and then conveying the air stream into a third compartment, downstream of the second compartment, housing one or more filters for fine dust separation and retaining.

In example methods, the hopper has an openable end in communication with each of the three compartments; and the method further includes: tilting the hopper to empty the hopper through the openable end.

In example methods, a door covers the openable end of the hopper; and the step of tilting includes using a pivot and actuator to selectively tilt the hopper.

### BRIEF DESCRIPTION OF THE DRAWINGS

FIG. 1 is a side section view of a hopper in a vacuum truck, constructed in accordance with principles of this disclosure;

FIG. 2 is a cross-section of the hopper in FIG. 1;

FIG. 3 is an enlarged view of a portion of the hopper of FIG. 1; and

FIG. 4. is a side view of an opposite side of the hopper of FIG. 1, and an end view of the hopper of FIG. 3.

### DETAILED DESCRIPTION

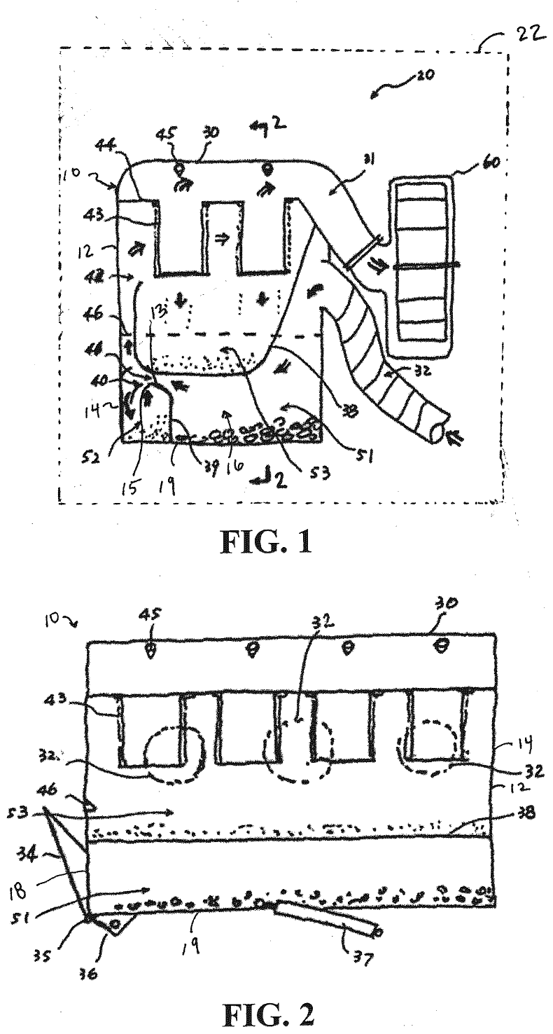

Road surface maintenance vehicles, such as street sweepers and road mark-line removers, generally use a vacuum system to pick up debris from the site and store it in a hopper. As shown in FIG. 1, the vacuum system 20 includes at least a debris collection and storage hopper system 10. The system 10 can be part of a vehicle 22 (e.g., street sweeper or road mark-line remover) having a pneumatic conveyance system using a blower or fan 60 to pickup debris from road surfaces. The vehicle 22 is shown schematically in FIG. 1.

A hopper 12 is provided to separate and store the debris from the air steam, and later, to discharge it to a waste collection site. Preferably, the hopper 12 is located behind the driver cab and in proximity over the rear axle.

Referring to FIGS. 1 and 2, the hopper 12 has a surrounding wall 14 defining an interior volume 16. The hopper 12 includes an airtight body 30, low pressure drop pre-separator 52 and at least one filter 43. The hopper body 30 is generally rectangular shaped to maximize the usage of available footprint in a vehicle 22, but could be other shapes.

The hopper 12 has at least one inlet 32 to receive a debris-transferring air stream. The hopper 12 has an outlet 31 which connects to the inlet of the vacuum generating blower or fan 60. From the outlet, filtered air is expelled from the hopper 12. Inside, substantially from-end-to-end partition walls 38 and 39 divide the hopper body 30 into three compartments. The first compartment is a main storage area 51. The second compartment is a pre-separator 52, and the third compartment is a filter housing 53.

On the wall 14 at a dumping side of the hopper body 30, there is an opening or gate 18 defined by height from a floor 19 of the hopper 12 to a horizontal frame member 46. The gate 18 is selectively opened or closed by door/chute 34, hinged at 35 near the floor 19. The hopper 12 is generally discharged by tipping, which is achieved by extending tilt cylinder 37 to rotate the hopper around pivot 36.

Note that both the partition walls 38 and 39 are at least partially lower than the frame member 46, so that the emptying process will discharge the contents of all three compartments 51, 52, 53.

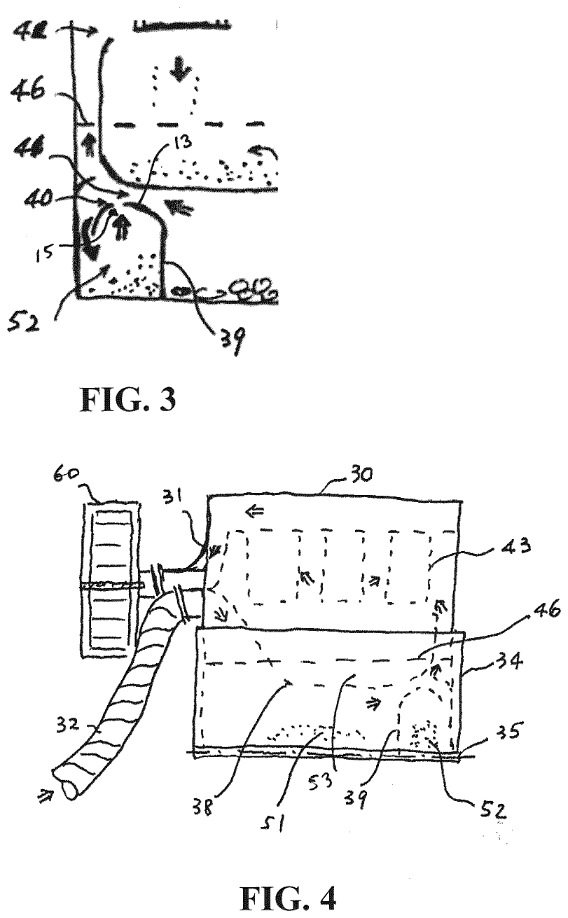

In operation, debris-entrained air flow, coming from the pickup nozzle(s) of the vehicle 22, enters the hopper body 30 via hose/pipe 32. After entering hopper body 30, the air stream will suddenly expend and lose its velocity, resulting in dropping off heavy and bulky materials into the main storage area 51. Some small debris and solid particles will continue to move on. In FIG. 3, it can be seen that at a pre-separator throat 41, the air steam velocity will increase again. While the air stream will follow a passage 46 nearly 90 degree upward turn around a substantially smooth round surface, heavy particles would keep moving straight and separating from the air stream. The curved wall 13, which forms the throat 41, is also a part of the pre-separate partition 39. In addition, at the narrowest part of the throat 41, there is a slot 15 at the curved wall 13 to create a venturi effect to cause a secondary air flow inside the pre-separator. This secondary flow will help to draw separated dust particles down into the separator collection area 52. More details on the low pressure drop separator can be referred to U.S. Pat. No. 10,258,912, incorporated herein by reference.

Now that the less dust-entrained air stream goes through the pre-separate and reaches the filter compartment from the side 42, the air flow will approach the filter 43 (or plural similar filters) at preferably a perpendicular direction to the falling dust cloud. Clean air will go through the filter(s) 43 into the outlet chamber 31, divided by wall 44. Caked debris on the filter(s) 43 will be blasted off, e.g. by pulsing compressed air from pulse heads 45 through the downstream/clean side of the filter(s) 43 to knock off the caked debris collected on the upstream side of the filter(s) 43. The knocked off debris is collected and retained in the third compartment 53.

The filtered air will continue to move through hopper outlet 31 and reach the blower and fan 60 and then either emit to atmosphere or recirculate to the pneumatic conveyance system.

Although the principles of this disclosure have been shown and described with respect preferred embodiments thereof, it should be understood by those skilled in the art that various changes and omissions, such as alternating the filters from horizontal arrangement to vertical, in the form and detail thereof may be made therein without departing from the spirit and the scope. It should also be appreciated that the exemplary embodiments are examples only, and are not intended to limit the scope, applicability, or configuration in any way.

What is claimed:

1. A debris collection and storage hopper system for use with a pneumatic conveyance system using a blower or fan to pickup debris from road surfaces; the system comprising:
(a) a hopper having a surrounding wall and an interior volume;
(b) at least one inlet in air-flow communication with the hopper interior volume conveying a debris-entrained air stream;
(c) an outlet in air-flow communication with the hopper interior volume conveying a filtered air stream;
(d) partition walls dividing the hopper interior volume into three compartments sequentially separating debris by mass and size, wherein the three compartments are constructed substantially across a length of the hopper; the hopper having an openable end in communication with each of the three compartments;
(e) a door covering the openable end of the hopper; and
(f) a pivot and actuator to selectively tilt the hopper for emptying through the openable end.

2. The debris collection and storage hopper system of claim 1, wherein the three compartments include:
(a) a first compartment positioned to receive the air stream directly from the inlet and to collect heavy and bulky debris;
(b) a second compartment having a throat and tuning profile to provide a low-pressure-drop separator to separate and retained coarse dust; and
(c) a third compartment housing one or more filters for fine dust separation and retaining.

3. A vehicle comprising the debris collection and storage hopper system of claim 1.

4. A vehicle comprising the debris collection and storage hopper system of claim 2.

5. A method of picking up debris from road surfaces; the method comprising:
(a) conveying a debris-entrained air stream into an interior of a hopper from an inlet;
(b) conveying the air stream into a first compartment in the hopper positioned to receive the air stream directly from the inlet and collecting heavy and bulky debris;
(c) then conveying the air stream into a second compartment, downstream of the first compartment, having a throat and tuning profile to provide a low-pressure-drop separator to separate and retain coarse dust; and
(d) then conveying the air stream into a third compartment, downstream of the second compartment, housing one or more filters for fine dust separation and retaining.

6. The method of claim 5, wherein the hopper has an openable end in communication with each of the three compartments; and the method further includes:
tilting the hopper to empty the hopper through the openable end.

7. The method of claim 6, wherein a door covers the openable end of the hopper; and
the step of tilting includes using a pivot and actuator to selectively tilt the hopper.
